(19) United States
(12) Patent Application Publication
(10) Pub. No.: US 2017/0309270 A1
(43) Pub. Date: Oct. 26, 2017

(54) ELECTRONIC APPARATUS, METHOD FOR CONTROLLING ELECTRONIC APPARATUS, AND RECORDING MEDIUM

(71) Applicant: KYOCERA CORPORATION, Kyoto (JP)

(72) Inventor: Akira MIZUMOTO, Yokohama-shi (JP)

(21) Appl. No.: 15/493,553

(22) Filed: Apr. 21, 2017

(30) Foreign Application Priority Data
Apr. 25, 2016 (JP) 2016-086851

(51) Int. Cl. G10L 13/08; G10L 13/033

(52) U.S. Cl. CPC G10L 13/08; G10L 13/033

(57) ABSTRACT

An electronic apparatus, a method for controlling an electronic apparatus, and a recording medium are disclosed. In one embodiment, an electronic apparatus includes an input unit, a sound output unit, and at least one processor configured to perform a copy process. In the copy process, the at least one processor causes the sound output unit to perform a speech output of first text information, judges whether a first input to the input unit has been done by a user during the speech output, and determines, when judging that the first input has been done, a copy range in the first text information based on a first timing of the first input.

### CROSS-REFERENCE TO RELATED APPLICATION

The present application claims priority under 35 U.S.C. §119 to Japanese Patent Application No. 2016-86851, filed on Apr. 25, 2016, entitled “ELECTRONIC APPARATUS, METHOD FOR CONTROLLING ELECTRONIC APPARATUS, CONTROL UNIT OF ELECTRONIC APPARATUS, CONTROL PROGRAM, AND ELECTRONIC APPARATUS SYSTEM”. The content of which is incorporated by reference herein in its entirety.

### FIELD

Embodiments of the present disclosure relate to an electronic apparatus, a method for controlling an electronic apparatus, and a recording medium.

### BACKGROUND

An electronic apparatus has been proposed which can output, by voice, a text displayed on a display screen. The user can recognize the contents of the display screen of the electronic apparatus without relying on his or her vision.

Another electronic apparatus has been proposed which can copy and paste information in response to the user's input. Such an electronic apparatus includes a touch panel. The touch panel detects the user's operation on the display screen of the electronic apparatus. The user can operate the display screen to specify, out of the information displayed on the display screen, a piece of information to be copied.

### SUMMARY

An electronic apparatus, a method for controlling an electronic apparatus, and a recording medium are disclosed. In one embodiment, an electronic apparatus includes an input unit, a sound output unit, and at least one processor configured to perform a copy process. In the copy process, the at least one processor causes the sound output unit to perform a speech output of first text information, judges whether a first input to the input unit has been done by a user during the speech output, and determines, when judging that the first input has been done, a copy range in the first text information based on a first timing of the first input.

In another embodiment, a method for controlling an electronic apparatus includes first to third steps. In the first step, a sound output unit is caused to perform a speech output of first text information. In the second step, it is judged whether a first input to an input unit has been done by a user during the speech output. When it is judged that the first input has been done, a copy range in the first text information is determined in the third step based on a first timing of the first input.

In another embodiment, a non-transitory computer readable recording medium is configured to store a control program for controlling an electronic apparatus. The control program causes the electronic apparatus to execute first to third steps. In the first step, a sound output unit is caused to perform a speech output of first text information. In the second step, it is judged whether a first input to an input unit has been done by a user during the speech output. When it is judged that the first input has been done, a copy range in the text information is determined in the third step based on a first timing of the first input.

### BRIEF DESCRIPTION OF THE DRAWINGS

FIG. 1 illustrates a schematic perspective view of an example of an external appearance of an electronic apparatus.

FIG. 2 illustrates a schematic rear view of an example of the external appearance of the electronic apparatus.

FIG. 3 illustrates a functional block diagram schematically showing an example of an electrical configuration of the electronic apparatus.

FIG. 4 illustrates a functional block diagram schematically showing an example of an internal configuration of a controller.

FIG. 5 schematically illustrates an example of a display screen on which a list of received mails is displayed.

FIG. 6 schematically illustrates an example of the display screen on which the detailed contents of a received mail are displayed.

FIG. 7 schematically illustrates an example of the display screen on which a menu is displayed.

FIG. 8 schematically illustrates an example of text information.

FIG. 9 illustrates a flowchart showing an example of a copy process.

FIG. 10 illustrates a flowchart showing an example operation performed by the electronic apparatus.

FIG. 11 illustrates a flowchart showing an example operation performed by the electronic apparatus.

FIG. 12 illustrates a flowchart showing an example operation performed in Step S9.

FIG. 13 illustrates a flowchart showing an example operation performed by the electronic apparatus.

FIG. 14 schematically illustrates an example of the text information.

FIG. 15 illustrates a flowchart showing an example operation performed by the electronic apparatus.

FIG. 16 illustrates a flowchart showing an example operation performed in Step S9′.

FIG. 17 illustrates a flowchart showing an example operation performed by the electronic apparatus.

FIG. 18 illustrates an example timing chart.

FIG. 19 illustrates a flowchart showing an example operation performed by the electronic apparatus.

FIG. 20 illustrates a flowchart showing an example operation performed by the electronic apparatus.

FIG. 21 illustrates a flowchart showing an example operation performed by the electronic apparatus.

FIG. 22 schematically illustrates part of the electrical configuration of the electronic apparatus.

FIG. 23 illustrates an example timing chart.

### DETAILED DESCRIPTION

### First Embodiment

Embodiments and modifications of the embodiments will be described below with reference to the drawings. In the drawings, the constituent components having similar configurations and functions are denoted by the same reference signs and the description common to these constituent components will not be repeated. Each drawing is merely a schematic illustration, and thus, the size of the individual structure and the positional relation among various structures in each drawing may be changed as appropriate.

### 1. Example of External Appearance of Electronic Apparatus

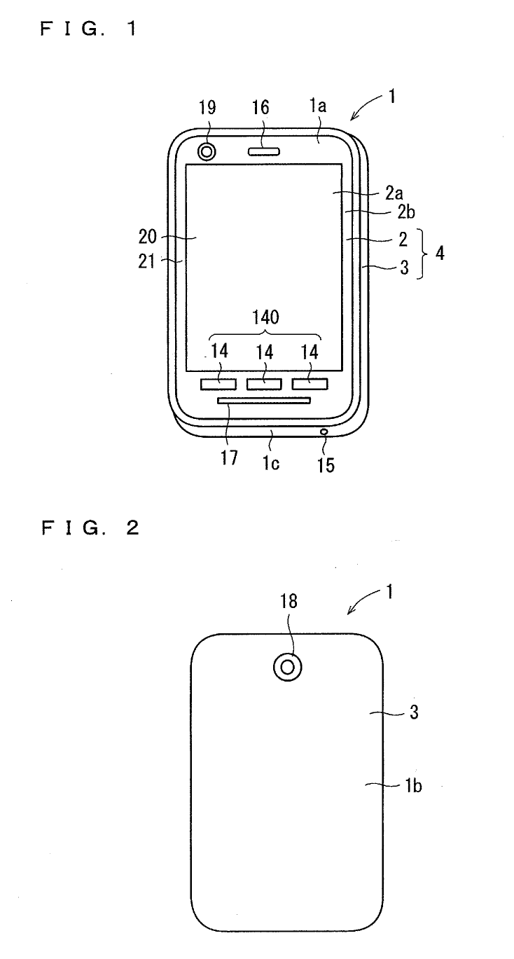

FIG. 1 illustrates a schematic perspective view of an example of an external appearance of an electronic apparatus 1. FIG. 2 illustrates a schematic rear view of an example of the external appearance of the electronic apparatus 1. The electronic apparatus 1 is, for example, a tablet, a personal digital assistant (PDA), a mobile phone such as a smartphone, or a personal computer. The electronic apparatus 1 can communicate with another communication apparatus via, for example, a base station and a server.

As illustrated in FIGS. 1 and 2, the electronic apparatus 1 includes an outer package (housing) 4. The outer package 4 includes, for example, a cover panel 2 located on a front surface 1a of the electronic apparatus 1 and an apparatus case 3 to which the cover panel 2 is attached. The outer package 4 of the electronic apparatus 1 has, for example, an approximately rectangular plate shape in a plan view.

Attached to a rear surface of the cover panel 2 is a display panel 121 and a touch panel 130, which will be described below. The cover panel 2, the display panel 121, and the touch panel 130 are laminated so as to be approximately parallel with each other. For example, the touch panel 130 is attached to the rear surface of the cover panel 2 and the display panel 121 is attached to the rear surface of the touch panel 130.

The cover panel 2 includes a display screen 2a on which various types of information such as characters, signs, and graphics displayed by the display panel 121 are displayed. A peripheral part 2b surrounding the display screen 2a in the cover panel 2 is, for example, mostly black because of a film or the like laminated thereon. Most of the peripheral part 2b of the cover panel 2 is a non-display area on which various types of information, which the display panel 121 displays, are not displayed.

The touch panel 130 can detect that an operator (such as a finger of the user) is in contact with the display screen 2a or is in close proximity to the display screen 2a. The user can operate the display screen 2a with the operator to provide various instructions to the electronic apparatus 1.

In the illustration of FIG. 1, located in an upper end portion or the like of the cover panel 2 is a second-lens transparent member 19 through which a lens of a second imaging unit 190, which will be described below, can be visually recognized from the outside of the electronic apparatus 1. In the upper end portion or the like of the cover panel 2, a receiver hole 16 is formed. In a lower end portion or the like of the cover panel 2, a speaker hole 17 is formed. Additionally, a microphone hole 15 is formed in, for example, a bottom surface 1c of the electronic apparatus 1, or, in a bottom surface (a lower side surface) of the apparatus case 3.

As illustrated in FIG. 2, located in a back surface 1b of the outer package 4 of the electronic apparatus 1, or, in an upper end portion or the like of a back surface of the apparatus case 3 is a first-lens transparent member 18 through which a lens of a first imaging unit 180, which will be described below, can be visually recognized from the outside of the electronic apparatus 1.

Provided on the electronic apparatus 1 are an operation button group 140 including a plurality of operation buttons 14. Each operation button 14 is a hardware button such as a press button. The operation button may also be referred to as an “operation key” or a “key”. Each operation button 14 is exposed from, for example, the lower end portion of the cover panel 2. The user can provide various instructions to the electronic apparatus 1 by operating each operation button 14 with a finger or the like.

The plurality of operation buttons 14 include, for example, a home button, a back button, and a history button. The home button is an operation button for causing a home screen (initial screen) to be displayed on the display screen 2a. The back button is an operation button for switching the display of the display screen 2a to its previous screen. The history button is an operation button for causing a list of applications executed by the electronic apparatus 1 to be displayed on the display screen 2a. In addition, the plurality of operation buttons 14 may include, for example, a menu button. The menu button is an operation button for causing a menu to be displayed on the display screen 2a. The menu includes a plurality of elements (which will be described below) functioning as input buttons.

### 2. Example of Electrical Configuration of Electronic Apparatus

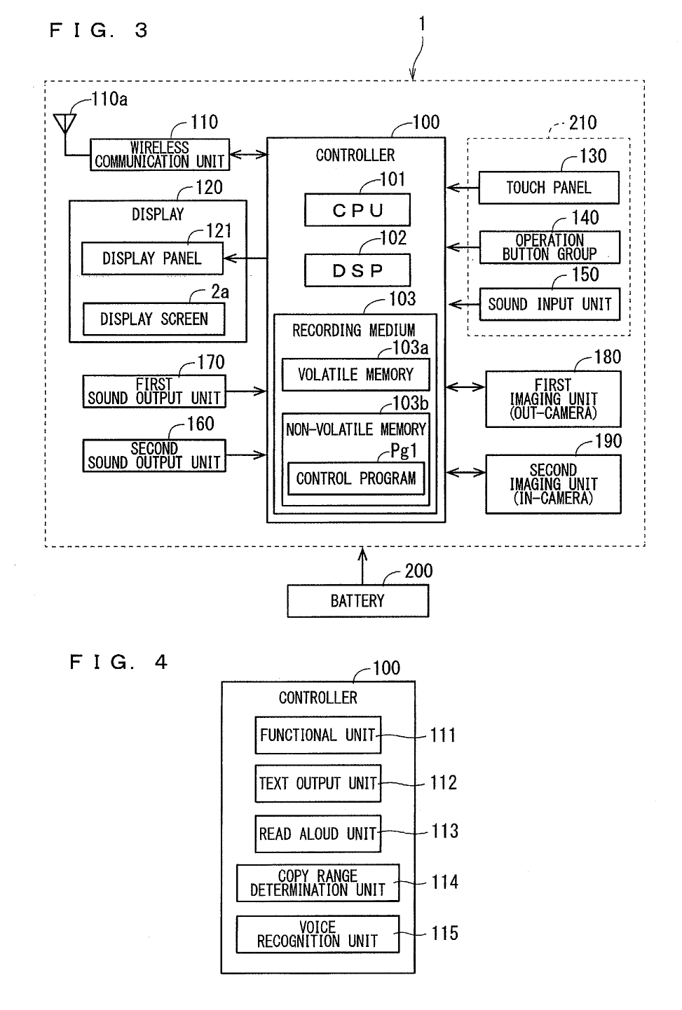

FIG. 3 is a functional block diagram schematically illustrating an example of the electrical configuration of the electronic apparatus 1. As illustrated in FIG. 3, the electronic apparatus 1 includes a controller 100, a wireless communication unit 110, a display 120, the touch panel 130, the operation button group 140, and a sound input unit 150. The electronic apparatus 1 also includes a first sound output unit 170, a second sound output unit 160, the first imaging unit 180, the second imaging unit 190, and a battery 200. The above-mentioned constituent components are accommodated in the outer package 4 of the electronic apparatus 1.

The controller 100 is, for example, a kind of arithmetic processing unit and includes, for example, electric circuits such as a central processing unit (CPU) 101, a digital signal processor 102, and a recording medium 103. The controller 100 can control other constituent components of the electronic apparatus 1 to perform overall control of the operation of the electronic apparatus 1. The electronic apparatus 1 may also include co-processors such as a system-on-a-chip (SoC), a micro control unit (MCU), and a field-programmable gate array (FPGA). The CPU and the co-processors may be used in cooperation or in a selective manner to perform various types of control of the electronic apparatus 1.

The electronic apparatus 1 includes at least one processor for providing control and processing capability to perform various functions as described in further detail below. In accordance with various embodiments, the at least one processor may be implemented as a single integrated circuit (IC) or as multiple communicatively coupled ICs and/or discrete circuits. It is appreciated that the at least one processor can be implemented in accordance with various known technologies.

In one embodiment, the processor includes one or more circuits or units configurable to perform one or more data computing procedures or processes by executing instructions stored in an associated memory, for example. In other embodiments, the processor may be implemented as firmware (e.g. discrete logic components) configured to perform one or more data computing procedures or processes.

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

The recording medium 103 is a recording medium readable by the CPU 101 and the DSP 102 and may include a volatile memory 103a and a non-volatile memory 103b. The volatile memory 103a is, for example, a random access memory (RAM). The non-volatile memory 103b is, for example, a read only memory (ROM). The ROM of the recording medium 103 is, for example, a flash ROM (flash memory) that is a non-volatile memory. The recording medium 103 can store, for example, a main program for controlling the electronic apparatus 1 and a plurality of application programs (also merely referred to as “applications” hereinafter). The CPU 101 and the DSP 102 execute various programs stored in the recording medium 103 to achieve various functions of the controller 100. The recording medium 103 can store, for example, a call application for performing a voice call and an imaging application for capturing a still image or a video using the first imaging unit 180 or the second imaging unit 190. The applications stored in the recording medium 103 include, for example, a control program Pg1 for controlling the electronic apparatus 1.

The recording medium 103 may include a non-transitory computer readable recording medium other than the ROM and the RAM. The recording medium 103 may include a compact hard disk drive, a solid state drive (SSD), and the like. In addition, another recording medium separate from the recording medium 103 may be provided. This recording medium may be located outside the controller 100. The information which will be described below may be stored in the recording medium 103 or another recording medium. All or some of the functions of the controller 100 may be achieved by hardware that needs no software to achieve the function above. That is, it is only required that the controller 100 be formed of a circuit.

The wireless communication unit (communication circuit) 110 includes a “communication interface” and includes an antenna 110a. The wireless communication unit 110 can receive, for example, a signal from a communication apparatus different from the electronic apparatus 1 or a signal from communication equipment such as a web server connected to the Internet through the antenna 110a via a base station. The wireless communication unit 110 can amplify and down-convert the signal received by the antenna 110a and then output a resultant signal to the controller 100. The controller 100 can, for example, demodulate the received signal to acquire various types of information (such as information indicating a sound or music or information indicating an email) contained in the received signal.

The wireless communication unit 110 can also up-convert and amplify a transmission signal generated by the controller 100 to wirelessly transmit the processed transmission signal from the antenna 110a. For example, the transmission signal from the antenna 110a is received, via the base station, by the mobile phone different from an electronic apparatus 1 or communication equipment such as the web server connected to the Internet.

The display 120 includes the display panel 121 and the display screen 2a. The display panel 121 is, for example, a liquid crystal panel or an organic electroluminescent (EL) panel. The display panel 121 can display various types of information such as characters, signs, and graphics under the control of the controller 100. The various types of information, which the display panel 121 displays, are displayed on the display screen 2a.

The touch panel 130 is, for example, a projected capacitive touch panel. The touch panel 130 can detect an operation performed on the display screen 2a with the operator such as a finger. When the user performs an operation on the display screen 2a with the operator such as the finger, an electrical signal corresponding to the operation is input from the touch panel 130 to the controller 100. The controller 100 can specify, based on the electrical signal from the touch panel 130, the purpose of the operation performed on the display screen 2a and accordingly perform processing appropriate to the purpose. The user can also provide various instructions to the electronic apparatus 1 by operating the display screen 2a with, for example, a pen for capacitive touch panel such as a stylus pen, instead of the operator such as the finger.

When the user operates each operation button 14 of the operation button group 140, the operation button 14 outputs, to the controller 100, an operation signal indicating that the operation button 14 is operated. The controller 100 can judge whether the individual operation button 14 has been operated based on the operation signal from the relevant operation button 14. The controller 100 can perform the processing corresponding to the operation button 14 that has been operated. Each operation button 14 may be a software button displayed on the display screen 2a, instead of a hardware button such as a press button. In this case, the touch panel 130 can detect an operation performed on the software button, so that the controller 100 can perform the processing corresponding to the software button that has been operated.

The sound input unit 150 is, for example, a microphone. The sound input unit 150 can convert the sound received from the outside of the electronic apparatus 1 into an electrical sound signal and then output the sound signal to the controller 100. The sound from the outside of the electronic apparatus 1 is, for example, taken inside the electronic apparatus 1 through, for example, the microphone hole 15 in the bottom surface (lower side surface) 1c of the apparatus case 3 and then is received by the sound input unit 150.

The touch panel 130 and the operation button group 140 are examples of an input unit 210 that can receive input to the electronic apparatus 1. In a case where the electronic apparatus 1 has the voice recognition function, the sound input unit 150 may be regarded as an example of the input unit 210. In this case, the user can input various types of instructions to the electronic apparatus 1 by voice. In a case where the electronic apparatus 1 has the gesture recognition function, the first imaging unit 180 and the second imaging unit 190, which will be described below, may be regarded as examples of the input unit 210. In this case, the user can input various types of instructions to the electronic apparatus 1 by using a spatial movement of his or her body.

In various embodiments, the input unit 210 may be implemented using any input technology or device known in the art such as, for example, a QWERTY keyboard, a pointing device (e.g., a mouse), a joy stick, a stylus, a touch screen display panel, a key pad, one or more buttons, etc., or any combination of these technologies.

The first sound output unit 170 is, for example, a dynamic speaker. The first sound output unit 170 can convert an electrical sound signal from the controller 100 into a sound and then output the sound. The sound output from the first sound output unit 170 is, for example, output to the outside of the electronic apparatus 1 through the speaker hole 17 in the lower end portion of the cover panel 2. The sound output through the speaker hole 17 is set to a volume such that the sound can be heard in the place apart from the electronic apparatus 1.

The second sound output unit 160 is, for example, a receiver. The second sound output unit 160 can convert an electrical sound signal from the controller 100 into a sound and then output the sound. The second sound output unit 160 can output, for example, a received sound. The sound output from the second sound output unit 160 is, for example, output to the outside through the receiver hole 16 in the upper end portion of the cover panel 2. The volume of the sound output through the receiver hole 16 is, for example, set to be lower than the volume of the sound output from the first sound output unit 170 through the speaker hole 17.

The second sound output unit 160 may include a piezoelectric vibration element. The piezoelectric vibration element can vibrate based on a sound signal from the controller 100. The piezoelectric vibration element is located on, for example, the rear surface of the cover panel 2. The piezoelectric vibration element can cause, through its vibration based on the sound signal, the cover panel 2 to vibrate. When the user brings the cover panel 2 close to his/her ear, the vibration of the cover panel 2 is transmitted to the user as a voice. The receiver hole 16 is not necessary when the second sound output unit 160 includes a piezoelectric vibration element.

Each of the first imaging unit 180 and the second imaging unit 190 includes a lens, an image sensor, and the like. The first imaging unit 180 is controlled by the controller 100. The image sensor of the first imaging unit 180 can receive light through the first-lens transparent member 18 and the lens. The first imaging unit 180 can generate a captured image and then output the captured image to the controller 100. The second imaging unit 190 is controlled by the controller 100. The image sensor of the second imaging unit 190 can receive light through the second-lens transparent member 19 and the lens. The second imaging unit 190 can generate a captured image and then output the captured image to the controller 100. The captured images may be still images. The first imaging unit 180 and the second imaging unit 190 can generate captured images repeatedly (e.g., at regular intervals) to create a video.

The lens of the first imaging unit 180 can be visually recognized from the first-lens transparent member 18 in the back surface 1b of the electronic apparatus 1. The first imaging unit 180 can thus image an object located on the back surface 1b side of the electronic apparatus 1. The first imaging unit 180 above is also referred to as an “out-camera”.

The lens of the second imaging unit 190 can be visually recognized from the second-lens transparent member 19 in the front surface 1a of the electronic apparatus 1. The second imaging unit 190 can thus image an object located on the front surface 1a side of the electronic apparatus 1. The second imaging unit 190 above is also referred to as an “in-camera”.

The battery 200 can output power for the electronic apparatus 1. The battery 200 is, for example, a rechargeable battery such as a lithium-ion secondary battery. The battery 200 can supply power to various electronic components such as the controller 100 and the wireless communication unit 110 of the electronic apparatus 1.

### 3. Example of Controller

FIG. 4 is a functional block diagram schematically showing an example of an internal configuration of the controller 100. The controller 100 includes a functional unit 111, a text output unit 112, a read aloud unit 113, a copy range determination unit 114, and a voice recognition unit 115. In the illustration of FIG. 4, the controller 100 includes the voice recognition unit 115, which may be eliminated. The voice recognition unit 115 will be described below in detail.

3-1. Functional Unit

The functional unit 111 can execute various functions of the electronic apparatus 1. The functional unit 111 can execute, for example, a voice call function, an email function, a social networking service (SNS) function, and a web browser function. The functional unit 111 can execute these functions to cause the display 120 to display various pieces of information. For example, the functional unit 111 can cause the display 120 to display the display information such as characters, images, or elements (e.g., icons) that function as input buttons.

Here, the email function will be described below as an example. The functional unit 111 can send and receive an email to and from another apparatus through the wireless communication unit 110. The functional unit 111 can store the email in the recording medium. Specifically, the functional unit 111 can store emails received from other apparatuses in the recording medium as received mails, and can store emails sent to other apparatuses in the recording medium as sent mails.

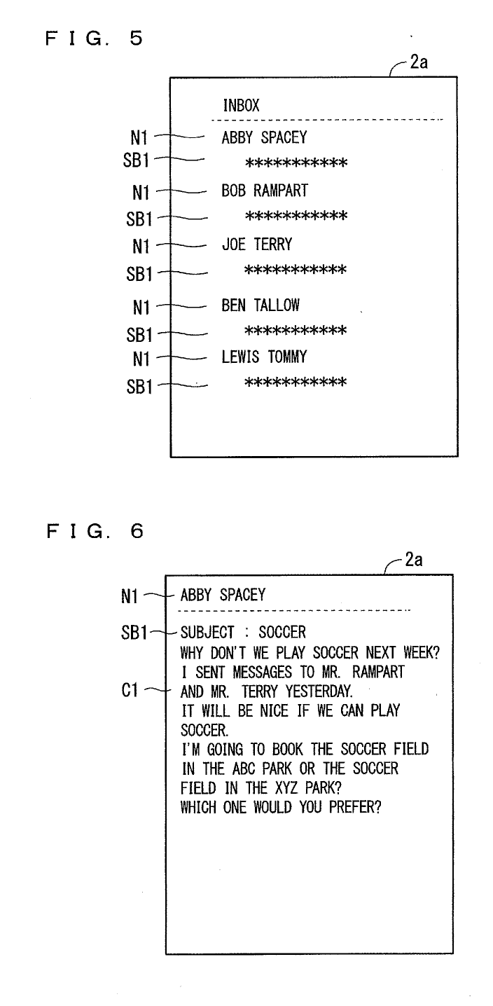

The functional unit 111 can cause the display 120 to display a list of emails in response to the user's input. FIG. 5 schematically illustrates an example of the display screen 2a on which a list of received mails is displayed. In the illustration of FIG. 5, sender's information N1 (e.g., names) and subject information SB1 indicative of a subject are displayed for each of the received mails.

The user can operate the input unit 210 to do selection input for selecting one mail from the list of received mails. For example, the displayed sender's information N1 and the displayed subject information SB1 may function as input buttons for use in the selection of received mail. In this case, the user operates, with the operator, the part on which the sender's information N1 or the subject information SB1 is displayed. In response to the user's selection input, the functional unit 111 causes the display 120 to display information on detailed contents of the received mail selected by the user (e.g., the sender's information N1, the subject information SB1, and body information). The “body information” refers to the body of the email. FIG. 6 schematically illustrates an example of the display screen 2a on which the information on the detailed contents of the received mail is displayed. In the illustration of FIG. 6, the sender's information N1, the subject information SB1, and body information C1 included in the received mail are displayed.

In response to the user's input, the functional unit 111 can also cause the display 120 to display a menu (which will be described below) including a plurality of elements that function as input buttons. For example, the user may perform an operation on the operation button 14 that functions as the menu button. In response to the operation, the functional unit 111 may cause the display 120 to display the menu. Alternatively, the controller 100 may cause the display 120 to display an element that functions as a menu button. In response to an operation performed on the element, the controller 100 may cause the display 120 to display the menu.

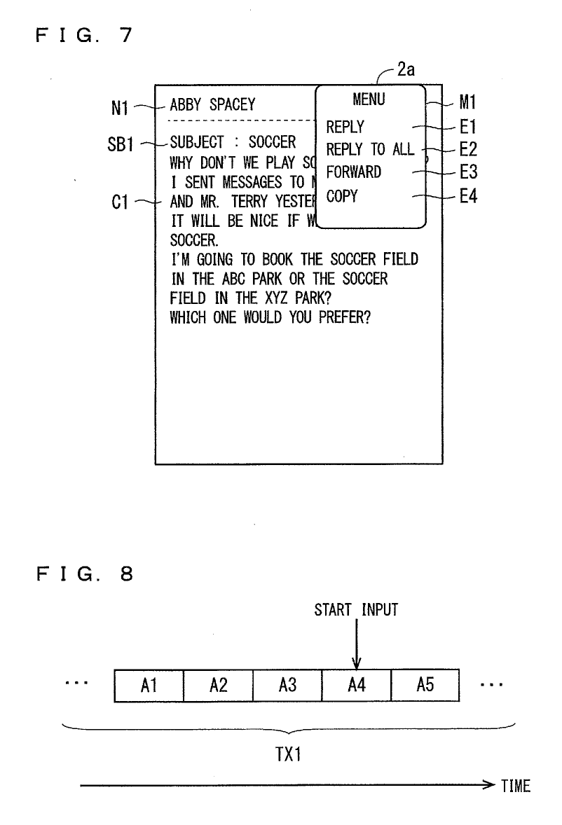

FIG. 7 schematically illustrates an example of the display screen 2a on which the menu is displayed. In the illustration of FIG. 7, a menu M1 is displayed on the display screen 2a. Under the menu M1, elements E1 to E4 that function as input buttons are displayed. For example, the element E1 is for use in sending a reply to only the sender of the received mail. The element E2 is for use in sending a reply to the sender and all of the recipients of the mail other than the user. The element E3 is for use in forwarding the received mail. The element E4 is an element for use in copying information.

The functional unit 111 can cause the display 120 to display a screen for writing an email (not shown) in response to the user's input to the element E1, E2, or E3. The user can operate the input unit 210 to input the body of the email and then input an instruction to send the email. The functional unit 111 can transmit the written email in response to the instruction.

When the user operates the element E4, the controller 100 can perform a copy process, which will be described below. Upon completion of the copy process, the controller 100 copies a piece of information. This will be described below in detail. The user operates the input unit 210 to input a paste position and an instruction to paste the piece of information, and then, the controller 100 pastes a copy of the piece of information to the paste position.

3-2. Read Aloud Unit

The read aloud unit 113 can receive input of text information from the text output unit 112. The text information is the data including character codes and may be, for example, data in text format. The read aloud unit 113 generates a sound signal indicative of the reading of the text information. Such a sound signal can be generated by using “speech synthesis technique”. Any algorithm may be used in the speech synthesis. For example, an algorithm such as the concatenative synthesis or the formant synthesis may be used. The read aloud unit 113 can output the sound signal to, for example, the first sound output unit 170. The first sound output unit 170 can convert the sound signal into a sound and then output the sound. The text information is output from the first sound output unit 170 by voice accordingly. The speech output of the text information is hereinafter also described as reading the text information aloud. The read aloud unit 113 may output the sound signal to the second sound output unit 160, and then, the second sound output unit 160 may output the text information by voice. The following will describe, as a representative example, the case in which the read aloud unit 113 causes the first sound output unit 170 to output the text information by voice.

3-3. Text Output Unit

The text output unit 112 can output the text information to the read aloud unit 113, as mentioned above. Examples of the text information include a text that describes the elements (e.g., the elements E1 to E4) displayed on the display screen 2a and functioning as the input buttons. For example, the user performs the first operation on the element. The first operation may be the act of bringing the operator close to or in contact with the display screen 2a. In response to the first operation, the text output unit 112 may output, to the read aloud unit 113, the text information describing the element. The text information may be associated with the element and stored in the recording medium. The read aloud unit 113 outputs the sound signal indicative of the reading of the text information to, for example, the first sound output unit 170. The first sound output unit 170 converts the sound signal into a sound and then outputs the sound to the outside. This can provide the user with the voice guidance on the function of the input button assigned to the element.

When the user performs, on the element, the second operation different from the first operation, the controller 100 performs the process corresponding to the element. Examples of the second operation include the act of bringing the operator close to or in contact with the display screen 2a and subsequently moving the operator away from the display screen 2a (a “tap operation”) twice within a predetermined period of time (a “double tap operation”).

Examples of the text information may also include display contents on the display screen 2a. For example, when the controller 100 causes the display 120 to display detailed contents of the received mail (see FIG. 6), the text output unit 112 may output the text information indicative of the detailed contents to the read aloud unit 113 or the like. The text output unit 112 may create the above-mentioned text information based on the sender's information N1, the subject information SB1, and the body information C1 included in the received mail. The detailed contents of the received mail that has been selected are output from, for example, the first sound output unit 170. The detailed contents of the received mail are read aloud to the user accordingly.

3-4. Copy Range Determination Unit

The copy range determination unit 114 can receive the text information from the text output unit 112. The text infatuation is delivered, for example, in text format. The copy range determination unit 114 can also receive, from the text output unit 112 or the read aloud unit 113, the information indicating which part of the text information is currently read aloud. A concrete example of the above-mentioned information will be described in another embodiment.

The copy range determination unit 114 can determine whether an input to the input unit 210 has been done during the speech output of the text information. When judging that the input has been done, the copy range determination unit 114 can determine the copy range in the text information based on the timing of input. Such an input may be done by the user on the operation button 14, which is not limited thereto. Alternatively, the controller 100 may display the element functioning as an input button on the display screen 2a. In this case, the above-mentioned input may be an operation performed on the element.

For example, the copy range determination unit 114 may determine the copy range in the text information, based on the section of the text information read aloud at the timing of input. Specifically, the copy range determination unit 114 determines, based on the section of the text information read aloud at the timing of the user's input, a demarcation point, which is the starting point or the endpoint of the copy rage. The following will describe, in greater detail, how the copy range is determined.

For example, the copy range determination unit 114 may determine the copy starting point based on the timing of input. The copy range determination unit 114 may designate, as the starting point, the section of the text information read aloud at the timing of the user's input. The input is hereinafter referred to as a start input.

FIG. 8 is a diagram illustrating an example of text information TX1. In the illustration of FIG. 8, sections A1 to A5 being part of the text information TX1 are shown. Each of the sections A1 to A5 may be regarded as one syllable. In the text information TX1, the sections A1 to A5 are arranged in the stated order. The sections A1 to A5 are read aloud in the started order accordingly. In the illustration of FIG. 8, the start input is done at the timing of the speech output of the section A4. In this case, the copy range determination unit 114 may designate the section A4 as the starting point of the copy range.

The following will describe a concrete example of the speech output of the contents of the received mail illustrated in FIG. 6. For example, the start input is done by the user at the timing of the speech output of “which” that is part of the sentence “Which one would you prefer?” included in the body information C1. The copy range determination unit 114 may designate “which” as the starting point of the copy range.

The copy range determination unit 114 may also determine whether an input (hereinafter referred to as an “end input”) to the input unit 210 has been done by the user during the speech output of the text information subsequently to the start input. When judging that the end input has been done, the copy range determination unit 114 may determine the endpoint of the copy range based on the timing of the end input. Although the end input is not limited to a particular input, the end input and the start input may be input of the same kind. Assume that the end input is done by the user at the timing of the speech output of “fer” that is part of the sentence “Which one would you prefer?” included in the body information C1. In this case, the copy range determination unit 114 may designate the syllable “fer” as the endpoint of the copy range. Alternatively, the copy range determination unit 114 may designate the question mark immediately following the syllable “fer” as the endpoint of the copy range.

3-5. Concrete Example of Operation

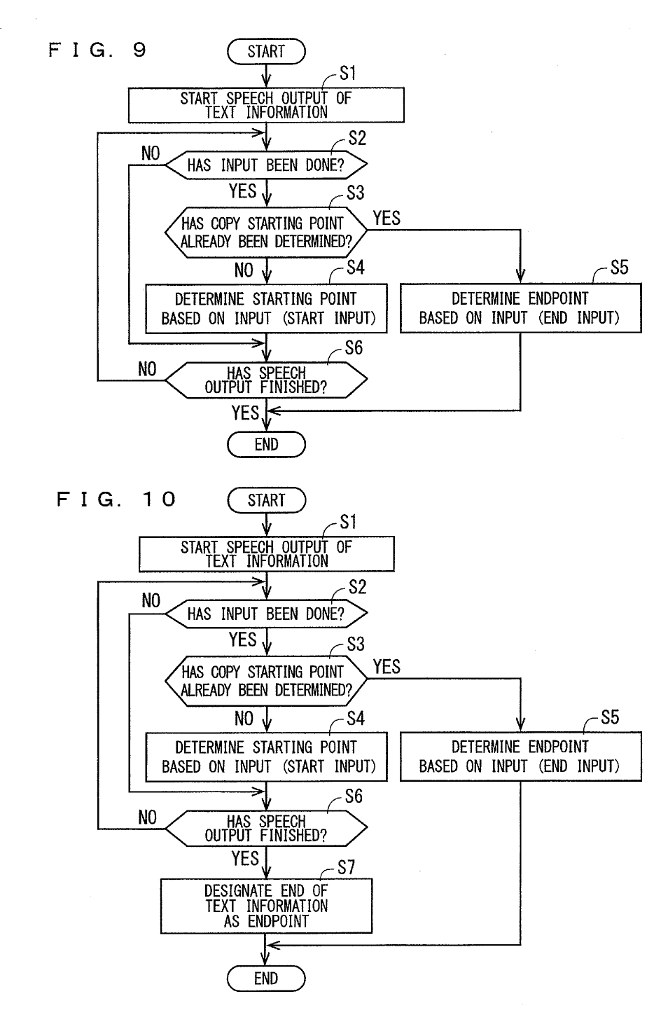

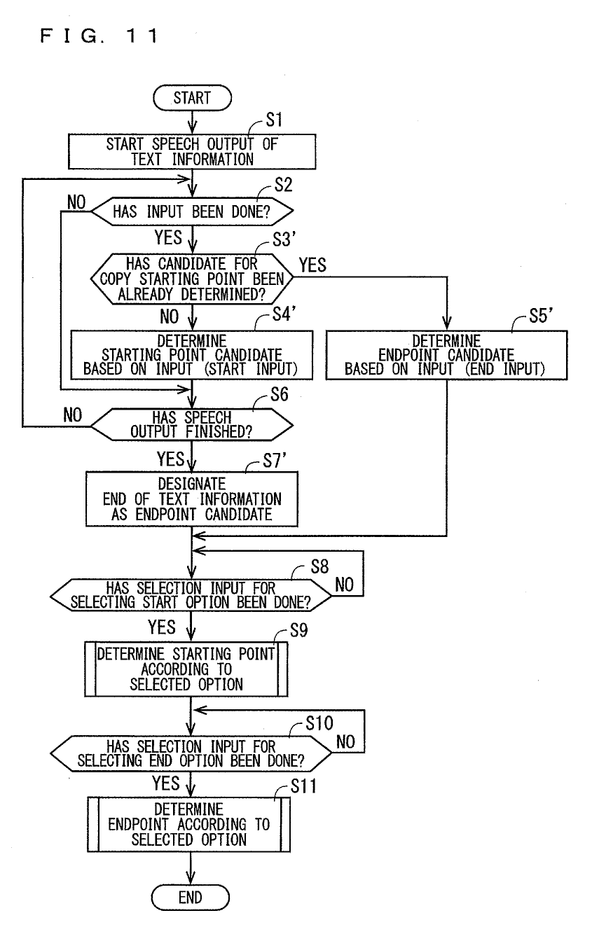

FIG. 9 illustrates a flowchart showing an example of the copy process. The copy process may be started upon satisfaction of any condition. For example, the controller 100 may start the copy process in response to the second operation performed by the user on the element E4. That is, the controller 100 may start the copy process in response to the user's input (operation on the element E4) for copying a piece of information.

For example, in Step S1, the first sound output unit 170 firstly starts the speech output of the text information. As a concrete example, the text output unit 112 outputs the text information including the detailed contents of an email to the read aloud unit 113. The read aloud unit 113 generates a sound signal indicative of the reading of the text information and then outputs the signal to, for example, the first sound output unit 170. The first sound output unit 170 converts the sound signal into a sound and then outputs the sound. The text information is read aloud accordingly.

Then, in Step S2, the copy range determination unit 114 judges whether an input to the input unit 210 has been done by the user. Thus, the copy range determination unit 114 judges whether an input has been done during the speech output of the text information. When the copy range determination unit 114 judges that no input has been done, the controller 100 judges in Step S6 whether the speech output of the text information has finished. For example, when the output of sound signals from the read aloud unit 113 is complete, the controller 100 may judge that the speech output of the text information has finished. When judging that the speech output of the text information has finished, the controller 100 ends the process. When the controller 100 judges that the speech output of the text information has not finished yet, the copy range determination unit 114 performs Step S2 again.

When judging in Step S2 that an input has been done, the copy range determination unit 114 judges in Step S3 whether the starting point of the copy range has already been determined. When judging that the copy starting point has not been determined yet, the copy range determination unit 114 determines the starting point in Step S4 based on the section of the text information read aloud at the timing of input. If the starting point has not been determined yet, the input in Step S2 functions as the start input.

Subsequently to Step S4, the controller 100 performs the process in Step S6.

When judging in Step S3 that the starting point has already been determined, the copy range determination unit 114 determines the copy endpoint in Step S5 based on the section of the text information read aloud at the timing of input. If the starting point has already been determined, the input in Step S2 functions as the end input. After determining the endpoint, the controller 100 ends the process.

When the character or letter of the user's choice is read aloud by the electronic apparatus 1, the user can, for example, do the start input to designate the character or letter as the starting point of the copy range. The same holds true for the endpoint. The controller 100 determines the copy range based on the timing of the input done during the speech output of the text information, as mentioned above. This enables the user, who may have bad eyesight, to readily input the copy range.

The controller 100 can copy a piece of information included in the copy range (copy information) from the text information. The copy information is, for example, data in text format.

The controller 100 may cause the first sound output unit 170 or the like to output the copy information. Specifically, the text output unit 112 outputs the copy information to the read aloud unit 113. The read aloud unit 113 generates a sound signal indicative of the reading of the copy information and then outputs the sound signal to, for example, the first sound output unit 170. The first sound output unit 170 converts the sound signal into a sound and then outputs the sound. The copy information is read aloud accordingly. The user thus becomes aware which part has been copied.

In some cases, characters or letters are not in a one-to-one correspondence with syllables. Kanji characters (Chinese characters used in Japanese writing) or alphabets constituting a word are not necessarily in a one-to-one correspondence with syllables. For example, two kanji characters constituting a Japanese word “Kinou”, which means “yesterday”, are not in a one-to-one correspondence with the Japanese syllabic characters. Similarly, the letters constituting the word “yesterday” are not in a one-to-one correspondence with syllables. In response to an input done during the speech output of a word, the copy range determination unit 114 may designate the beginning of the word as the starting point. In response to the start input done during the speech output of the word “yesterday”, the copy range determination unit 114 may designate the first letter “y” as the starting point. Although it is not always required that the beginning of a word be designated as the starting point, the user often designates the beginning of the word as the starting point of the copy range. Thus, the copy range determination unit 114 can realistically determine the copy range by designating the beginning of a word as the starting point.

In some cases, the start input is done at a timing in between two characters or two letters during the speech output. The copy range determination unit 114 may designate, as the starting point, the character or letter read aloud immediately before or after the first timing. In response to the start input done at a timing in between two words, the copy range determination unit 114 may designate, as the starting point, the beginning of the word read aloud immediately before or after the timing of the start input.

In response to the end input during the speech output of a word, the copy range determination unit 114 may designate the end of the word as the endpoint. It is not always required that the end of a word be designated as the endpoint. In a case where the word is followed by a punctuation mark such as a period, a comma, an exclamation mark, or a question mark, the copy range determination unit 114 may designate the punctuation mark as the endpoint of the copy range. Thus, the copy range can be realistically determined.

In response to the end input done at a timing in between two characters or two letters during the speech output, the copy range determination unit 114 may designate, as the endpoint, the character or letter read aloud immediately before the second timing. In response to the end input done at a timing in between two words, the copy range determination unit 114 may designate, for example, the end of the word read aloud immediately before the timing of the end input.

### 4. Example Method for Determining Copy Range

4-1. Example Method for Determining Endpoint

In the illustration of FIG. 9, in a case where only the start input has been done during the speech output of the text information, the starting point of the copy range is determined. However, no endpoint is determined. Alternatively, the copy range determination unit 114 may designate the end of the text information as the endpoint at the completion of the speech output of the text information, with no end input for determining the endpoint been done subsequently to the start input for determining the starting point.

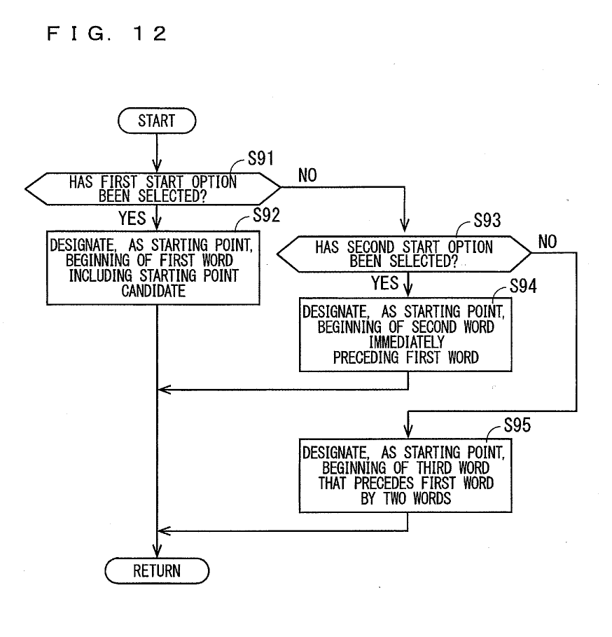

FIG. 10 illustrates an example of the above-mentioned operation performed by the electronic apparatus 1. In addition to the steps illustrated in FIG. 9, Step S7 is performed by the controller 100. When judging in Step S6 that the speech output of the text information has finished, the copy range determination unit 114 performs Step S7. In Step S7, the copy range determination unit 114 designates the end of the text information as the endpoint of the copy range.

4-2. Determining Starting Point and Endpoint Based on Input

4-2-1. User's Adjustment

The user may fail to do an input at the timing of his or her choice. For example, the user may do an input after hearing the speech output of the character or letter of his or her choice included in the text information. The input may lag behind the timing of the user's choice accordingly. In some cases, the user may do the start input while the word following the word of his or her choice is read aloud. Thus, a technique is proposed which is for use in changing the copy starting point or the copy endpoint after the start input or the end input.

An example configuration of the electronic apparatus 1 is as illustrated in FIGS. 1 to 4. Note that the copy range determination unit 114 designates, as a copy range candidate, the copy range determined by the above-mentioned method. In other words, the copy range determination unit 114 tentatively determines the copy range based on the input done during the speech output of the text information.

FIG. 11 illustrates a flowchart showing an example operation performed by the electronic apparatus 1. The controller 100 performs Steps S3′ to S5′ and Step S7′ in place of Steps S3 to S5 and Step S7 illustrated in FIG. 10 and further performs Steps S8 to S11 in addition to the remaining steps illustrated in FIG. 10. Steps S3′ to S5′ and Step S7′ are performed upon satisfaction of the conditions for Steps S3 to S5 and Step S7, respectively. For example, when judging in Step S2 that an input has been done, the controller 100 performs Step S3′.

In Step S3′, the copy range determination unit 114 judges whether a candidate for the starting point of the copy range has already been determined. When judging that no candidate for the starting point has been determined, in Step S4′, the copy range determination unit 114 determines a candidate for the starting point in the text information based on the timing of the input done in Step S2. For example, the section read aloud at the timing of input is designated as a candidate for the starting point, as in the above description. Subsequently, the controller 100 performs Step S6.

When judging in Step S3′ that a candidate for the starting point has already been determined, in Step S5′, the copy range determination unit 114 determines a candidate for the endpoint in the text information based on the timing of the input done in Step S2. For example, the section read aloud at the timing of input is designated as a candidate for the endpoint, as in the case of determining the starting point.

In Step S7′, the copy range determination unit 114 designates the end of the text information as a candidate for the endpoint.

As mentioned above, a candidate for the starting point of the copy range and a candidate for the endpoint of the copy range are determined. Then, the copy range determination unit 114 determines the starting point of the copy range based on both the candidate for the starting point and an input subsequently done by the user, and determines the endpoint of the copy range based on both the candidate for the endpoint and an input subsequently done by the user, as will be described below in detail.

4-2-1-1. Options

The controller 100 offers N options (N being an integer greater than or equal to 2) based on the candidate for the starting point. Each option indicates the starting point of the copy range. The options above are hereinafter also referred to as start options.

The user often selects the beginning of a word as the copy starting point. The following will describe an example case in which a predetermined part of any word may be designated as the starting point.

For example, the first start option indicates the beginning of the first word including the candidate for the starting point. The first word can be regarded as the word read aloud at the timing of the user's start input. The K-th (K being an integer greater than or equal to 2 and smaller than or equal to N) start option indicates, for example, the beginning of the K-th word that precedes the first word by (K−1) words.

With reference to the drawings including FIG. 8, the following will describe the case in which the first to third start options are offered. Assume that each of the sections A1 to A5 indicates a word. For example, the first start option indicates the beginning of the word A4 read aloud at the timing of the start input. In other words, the first start option indicates the beginning of the word A4 including the candidate for the starting point determined based on the start input. The second start option indicates the beginning of the word A3 immediately preceding the word A4. The third start option indicates the beginning of the word A2 that precedes the word A4 by two words.

With reference to FIG. 11, the copy range determination unit 114 judges, in Step S8 subsequent to Step S5′ or Step S7′, whether the user has done the first selection input for selecting one start option from among N start options. The first selection input is done by using the input unit 210.

When judging that the first selection input has not been done, the copy range determination unit 114 performs Step S8 again. When judging that the first selection input has been done, in Step S9, the copy range determination unit 114 determines the starting point based on the selected start option. Specifically, the copy range determination unit 114 designates, as the starting point, the beginning of the word indicated by the selected option. In a case where the user selects the second start option, the copy range determination unit 114 designates the beginning of the word A3 as the starting point.

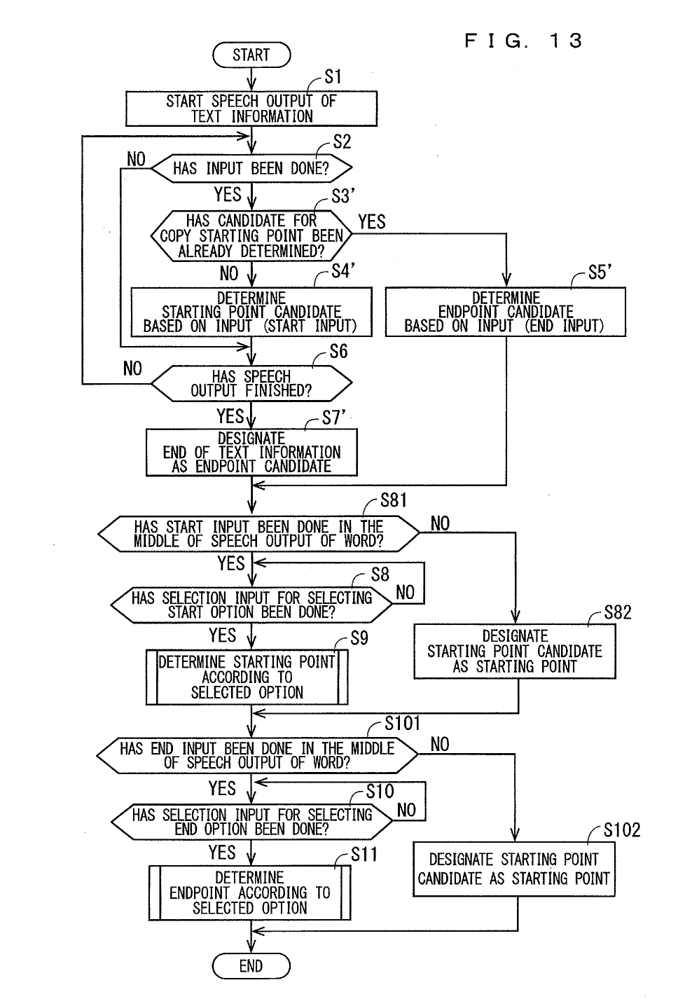

FIG. 12 illustrates a flowchart showing a concrete example of the process of Step S9. The flowchart illustrates an example operation performed by the copy range determination unit 114 in the state in which the first to third start options are available as mentioned above. Firstly, in Step S91, the copy range determination unit 114 judges whether the first start option has been selected. When judging that the first start option has been selected, in Step S92, the copy range determination unit 114 designates, as the starting point, the beginning of the word A4 including the starting point candidate determined based on the start input.

When judging that the first start option has not been selected, the copy range determination unit 114 judges in Step S93 whether the second start option has been selected. When judging that the second start option has been selected, in Step S94, the copy range determination unit 114 designates, as the starting point, the beginning of the word A3 immediately preceding the word A4. When judging that the second start option has not been selected, or, that the third start option has been selected, in Step S95, the copy range determination unit 114 designates, as the starting point, the beginning of the word A2 that precedes the word A4 by two words.

In the case where the user's start input lags behind the timing of the speech output of the word of the user's choice as mentioned above, the beginning of the word of the user's choice can be designated as the starting point of the copy range. The start options are offered based on the starting point candidate. Thus, the start options available are words close to the candidate. In the case where a small number of start options are available, it is more likely that the word of the user's choice be included in the start options. The user can easily make a choice among a small number of start options.

The start options available in the above-mentioned example are the words A2 and A3 that precede the word A4 as well as the word A4 read aloud at the timing of the start input (the word including the starting point candidate). In other words, each of N start options indicates a character or a letter that precedes the starting point candidate. This method has an advantage especially in the case in which the user hears a word and then does the start input. The user's start input often lags behind the timing of the speech output of the word of the user's choice. In such a case, the word of the user's choice precedes the starting point candidate. When the words that precede the starting point candidate are available as the start options, the word of the user's choice is probably included in the start options.

In a case where the user knows the text information, meanwhile, the user hears the speech output of the text information while predicting which word will be subsequently read aloud. In this case, the user can do the start input immediately before the word of his or her choice is read aloud. Thus, the start option that indicates the word (e.g., the word A5) following the word A4, which includes the starting point candidate, may be offered. In the case where the user's start input is done immediately before the word of the user's choice is read aloud, the word of the user's choice can be included in the start options.

The number of the start options indicating the words that precede the word A4, which includes the starting point candidate, may be greater than the number of the start options indicating the words following the word A4 because the user, more often than not, hears the speech output of a word and then does the start input.

The endpoint will be described below. Similarly to the starting point, the endpoint is selected from among the options. N options from which the endpoint is to be selected are offered based on the endpoint candidate. The above-mentioned options are hereinafter referred to as end options.

The first end option indicates, for example, the end of the first word including the endpoint candidate determined based on the end input. The first word is the word read aloud at the timing of the user's end input. The K-th end option indicates, for example, the end of the K-th word that precedes the first word by (K−1) words.

Assume that the first to third end options are offered. The first end option indicates the end of the first word that has been read aloud at the timing of the end input. The second end option indicates the end of the second word immediately preceding the first word. The third end option indicates the end of the third word that precedes the first word by two words.

In the illustration of FIG. 11, in Step S10 subsequent to Step S9, the copy range determination unit 114 judges whether the user has done the second selection input for selecting one end option from among N end options. The second selection input is done by using the input unit 210. When judging that the second selection input has not been done, the copy range determination unit 114 performs Step S10 again. When judging that the second selection input has been done, in Step S11, the copy range determination unit 114 determines the endpoint based on the selected end option. Specifically, the copy range determination unit 114 designates, as the endpoint, the end of the word indicated by the selected end option. In response to the user's input for selecting the second end option, the copy range determination unit 114 designates, as the endpoint of the copy range, the end of the second word immediately preceding the first word.

In the case where the user's end input lags behind the timing of the speech output of the word of the user's choice as mentioned above, the end of the word of the user's choice can be designated as the endpoint of the copy range. Furthe nore, words close to the endpoint candidate are available as the end options.

N end options may be characters or letters that precede the endpoint candidate. This is suited for the case in which the user hears a word and then does the end input.

In some embodiments, one of the words following the endpoint candidate may be available as the end option. The number of the end options preceding the endpoint candidate may be greater than the number of the end options following the endpoint candidate. The number of the end options and the number of the start options are not necessarily the same and may be different from each other.

The above-mentioned process is based on the assumption that the end input fails to coincide with the timing of the user's choice. Meanwhile, in Step S7′, the endpoint candidate is determined, regardless of the end input. The copy range determination unit 114 may designate, as the endpoint, the endpoint candidate determined in Step S7′. At the completion of the speech output of the text information with no end input being done, the copy range determination unit 114 may designate the end of the text information as the endpoint without performing Steps S10 and S11.

The combination of Steps S8 and S9 and the combination of Steps S10 and S11 illustrated in FIG. 11 may be performed in reverse order.

4-2-1-2. Conditions

The copy range determination unit 114 may determine the starting point based on the start input on the assumption that the user has successfully done the start input at the timing of his or her choice. The copy range determination unit 114 may determine the starting point based on the options on the assumption that the user has failed to do the start input at the timing of his or her choice.

The starting point of the copy range, more often than not, is the beginning of a word. In the case where the user's start input coincides with the speech output of the beginning of the word, the user has conceivably done the start input in order to designate the beginning of the word as the starting point. In the case where the timing of the user's start input is in between two words, the user has conceivably done the start input in order to designate the beginning of the latter word as the starting point. In the case where the timing of the user's start input is in the middle of the speech output of a word, the timing of the user's start input has conceivably failed to coincide with the timing of the user's choice.

The copy range determination unit 114 may judge whether the start input has been done in the middle of the speech output of a word. When making a positive judgment, the copy range determination unit 114 may determine the starting point based on the start options. When making a negative judgment, the copy range determination unit 114 may determine the starting point based on the start input. Similarly, the copy range determination unit 114 may judge whether the end input has been done in the middle of the speech output of a word. When making a positive judgment, the copy range determination unit 114 may determine the endpoint based on the end options. When making a negative judgment, the copy range determination unit 114 may designate, as the endpoint, the section of the text information read aloud at the timing of the user's end input.

FIG. 13 illustrates a flowchart showing an example of the above-mentioned operation performed by the electronic apparatus 1. The controller 100 performs Steps S81, S82, S101, and S102 in addition to the steps illustrated in FIG. 11. Step S81 is performed immediately before Step S8. In Step S81, the copy range determination unit 114 judges whether the start input has been done in the middle of the speech output of a word. When making a positive judgment, the copy range determination unit 114 performs Step S8. When making a negative judgment, in Step S82, the copy range determination unit 114 designates the starting point candidate as the starting point. If the start input has not been done in the middle of the speech output of a word, the copy range determination unit 114 determines the starting point based on the start option selected by the user (Steps S8 and S9). If the start input has been done in the middle of the speech output of a word, the copy range determination unit 114 designates, as the starting point, the starting point candidate determined in Step S4′ (Step S82).

In Step S9 or in Step S101 subsequent to Step S82, the copy range determination unit 114 judges whether the end input has been done in the middle of the speech output of a word. When making a positive judgment, the copy range determination unit 114 performs Step S10. When making a negative judgment, in Step S1012, the copy range determination unit 114 designates the endpoint candidate as the endpoint. If the end input has not been done in the middle of the speech output of a word, the copy range determination unit 114 determines the endpoint based on the end option selected by the user (Steps S10 and S11). If the end input has been done in the middle of the speech output of a word, the copy range determination unit 114 designates, as the endpoint, the endpoint candidate determined in Step S5′ (Step S102).

The combination of Steps S8, S9, S81, and S82 and the combination of Steps S10, S11, S101, and S102 may be performed in reverse order.

4-2-1-3. Retrying Copy Process

There is a possibility that the word of the user's choice is not included in the options. In a case where there is a large discrepancy between the timing of the speech output of the word of the user's choice and the timing of the start input or the end input, the word of the user's choice may not be included in the options. The input unit 210 may accept an input (referred to as a “retry input”) for retrying the copy process. In response to the retry input, the controller 100 performs the copy process again from the beginning. Specifically, in response to the retry input, the controller 100 performs Step S1. This makes the electronic apparatus 1 more convenient to use.

The input unit 210 may also accept the retry input in the copy process illustrated in FIG. 9 and the copy process illustrated in FIG. 10. For example, in response to the user's retry input to the input unit 210 in the middle of the copy process, the controller 100 performs the copy process again from the beginning. The copy process can be performed again from the beginning in response to the retry input done by the user, who has failed to do the input at the timing of his or her choice.

4-2-1-4. Inputting String

In the above-mentioned example, the user has done the selection input for selecting a start option in order to determine the starting point of the copy range. The following will describe the case in which the user does a string input to the input unit 210 for inputting a string in order to determine the starting point. The string is hereinafter referred to as a “start string”.

The copy range determination unit 114 may judges whether the first string that matches the start string is included in the text information. The copy range determination unit 114 may make such a judgment using a search algorithm for finding the string. When judging that the first string is included in the text information, the copy range determination unit 114 may designate, for example, the beginning of the first string as the starting point of the copy range.

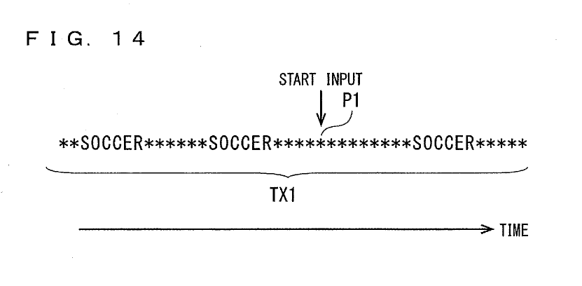

In a case where a plurality of the first strings are included in the text information, the copy range determination unit 114 may designate, for example, the beginning of the first string closest to the starting point candidate as the starting point. FIG. 14 schematically illustrates an example of the text information TX1. Each asterisk in FIG. 14 indicates a given character or letter. In the illustration of FIG. 14, the text information TX1 includes three strings, each of which represents the word “soccer”.

In the illustration of FIG. 14, the timing of the start input is also shown. The start input has been done during the speech output of the letter located between the second “soccer” and the third “soccer” included in the text information TX1. The timing of the speech output of the second “soccer” is closer to the timing of the start input than the timing of the speech output of the third “soccer” is. In the illustration of FIG. 14, a starting point candidate P1 is also shown. The candidate P1 is, for example, the letter that has been read aloud at the timing of the start input. As illustrated in FIG. 14, in the text information TX1, the beginning of the second “soccer” is closer to the candidate P1 than the beginning of the third “soccer” is.

When the user inputs the start string representing the word “soccer”, the copy range determination unit 114 judges whether “soccer” is included in the text information TX1. In the illustration of FIG. 14, three first strings, each of which represents the word “soccer”, are included. The copy range determination unit 114 calculates the distance between the starting point candidate P1 and each of the three first strings in the text information TX1. The distance may be expressed as, for example, the number of letters. For example, the copy range determination unit 114 designates, as the starting point, the beginning of the second “soccer”, which is closest to the candidate P1 among the three first strings.

In the case where there is a discrepancy between the timing of the user's start input and the timing of the user's choice, the point of the user's choice can be designated as the starting point, as mentioned above. The user does not need to make a selection from among the options.

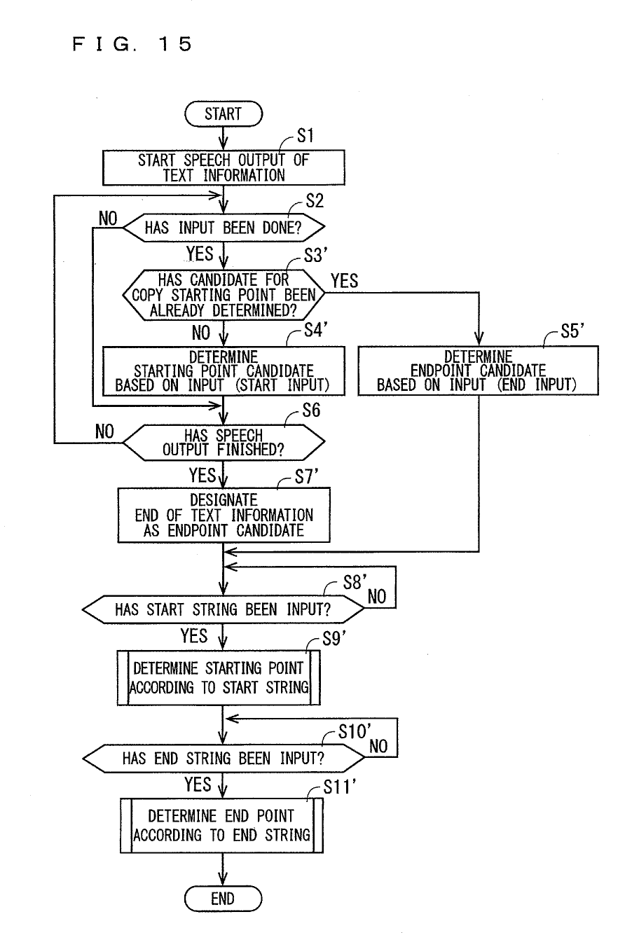

FIG. 15 illustrates a flowchart showing an example of the above-mentioned operation performed by the electronic apparatus 1. The controller 100 performs Steps S8′ to S11′ in place of Steps S8 to S11 of FIG. 11. The individual conditions for performing Steps S8′ to S11′ are similar to the individual conditions for performing Steps S8 to S11.

Step S8′ is performed subsequently to Step S5′ or Step S7′. In Step S8′, the copy range determination unit 114 judges whether the start string has been input. When judging that the start string has not been input, the copy range determination unit 114 performs Step S8′ again. When judging that the start string has been input, in Step S9′, the copy range determination unit 114 determines the starting point according to the start string.

FIG. 16 illustrates an example operation performed in Step S9′. Firstly, in Step S91′, the copy range determination unit 114 judges whether the first string that matches the start string is included in the text information. When judging that the first string is not included, the controller 100 performs an error process in Step S92′. For example, the controller 100 may output a sound for prompting the user to input the start string and then perform Step S8′ again. Alternatively, the controller 100 may end the operation.

When judging that the first string is included in the text information, in Step S93′, the copy range determination unit 114 judges whether a plurality of the first strings are included in the text information. When judging that a plurality of the first strings are included, in Step S94′, the copy range determination unit 114 designates, for example, the beginning of the first string closest to the starting point candidate in the text information as the starting point. When judging that a plurality of the first strings are not included, in Step S95′, the copy range determination unit 114 designates, for example, the beginning of the first string as the starting point.

The same holds true for the endpoint. The user may operate the input unit 210 to input a string in order to determine the endpoint. The string is hereinafter referred to as an “end string”.

The copy range determination unit 114 judges whether the second string that matches the end string is included in the text information. When judging that the second string is included in the text information, the copy range determination unit 114 may designate the end of the second string as the endpoint of the copy range.

In a case where a plurality of the second strings are included in the text information, the copy range determination unit 114 may designate, for example, the end of the second string closest to the endpoint candidate as the endpoint.

With reference to FIG. 15, in Step S10′ subsequent to Step S9′, the copy range determination unit 114 judges whether the end string has been input. When judging that the end string has not been input, the copy range determination unit 114 performs Step S10′ again. When judging that the end string has been input, in Step S11′, the copy range determination unit 114 determines the endpoint according to the end string as in the case of determining the starting point.

The combination of Steps S8′ and S9′ and the combination of Steps S10′ and S11′ may be performed in reverse order. The condition described with reference to FIG. 13 is applicable to the process illustrated in FIG. 15. The retry input is also applicable to the process illustrated in FIG. 15.

4-2-1-4-1. Determining Starting Point and Endpoint Based on String

The user may hear the word of his or her choice and then do the start input or the end input. In such a case, the input, more often than not, lags behind the speech output of the word of the user's choice. Thus, the word of the user's choice in the text information is likely to be followed by the starting point candidate or the endpoint candidate determined based on the input. That is, the word of the user's choice is likely to precede the candidate.

When judging that a plurality of the first strings are included in the text information, the copy range determination unit 114 may determine the starting point based on the first string preceding the starting point candidate. Specifically, the copy range determination unit 114 may designate, as the starting point, the beginning of the first string preceding the starting point candidate and closest to the starting point candidate. The first string following the starting point candidate is not designated as the starting point. Instead, the first string preceding the starting point candidate is designated as the starting point.

With reference to FIG. 14, assume that the third “soccer” is closer to the starting point candidate P1 than the second “soccer” is. Note that the candidate P1 is followed by the third “soccer”. In such a case, the copy range determination unit 114 designates, for example, the beginning of the second “soccer” as the starting point.

Similarly, in the case where a plurality of the second strings are included in the text information, the copy range determination unit 114 may designate, as the endpoint, the end of the second string preceding the endpoint candidate and closest to the endpoint candidate.

In the case in which the user hears the speech output of a word and then does the end input, the starting point or the endpoint can be appropriately determined.

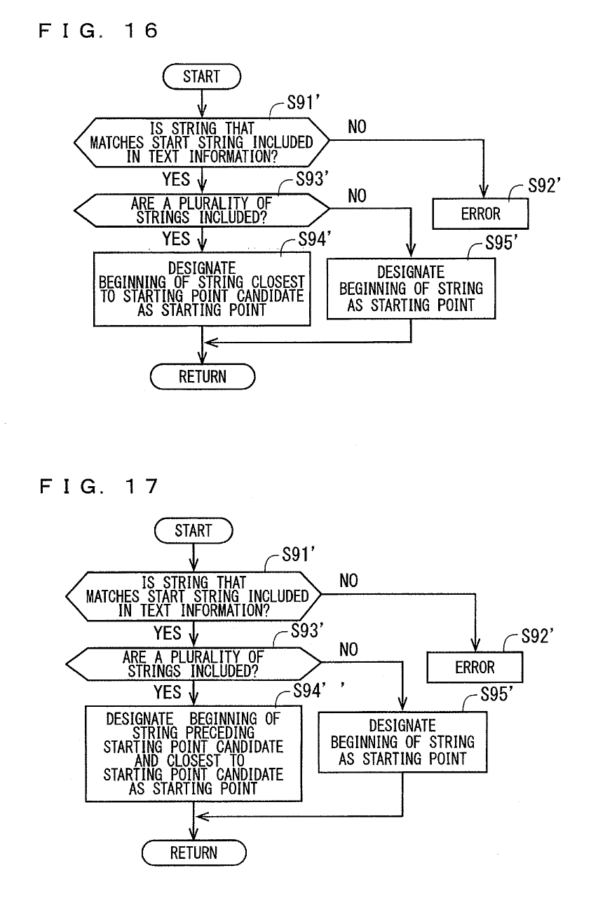

FIG. 17 illustrates a flowchart showing an example of the above-mentioned operation performed by the electronic apparatus 1. The controller 100 performs Step S94″ in place of Step S94′ of FIG. 16. When judging in Step S93′ that a plurality of the first strings are included, the copy range determination unit 114 performs Step S94″. In Step S94″, the copy range determination unit 114 calculates the distance between the starting point candidate and each of the first strings preceding the starting point candidate. Then, the copy range determination unit 114 designates, as the starting point, the beginning of the first string closest to the starting point candidate.

4-2-1-5. Voice Input

The selection input for making a selection from among options, the string input for inputting a string, and the retry input for retrying the copy process are not limited to particular methods. For example, voice input may be used. With reference to FIG. 4, the controller 100 includes, for example, the voice recognition unit 115. The voice recognition unit 115 can receive input of a sound signal from the sound input unit 150. That is, a sound uttered by the user is received by the voice recognition unit 115 through the sound input unit 150. The voice recognition unit 115 can recognize the word indicated by the received sound signal. Any voice recognition method is applicable. For example, the voice recognition unit 115 may perform matching for the sound signal on the data concerning characteristics of voice prestored in the recording medium, thus recognizing the speech output indicated by the sound signal.

For example, the user may utter a number for specifying an option. The voice is recognized by the voice recognition unit 115. The voice recognition unit 115 outputs the recognition result to the copy range determination unit 114. As mentioned above, the copy range determination unit 114 determines the starting point or the endpoint according to the received option.

Alternatively, the user may utter a string. The voice is recognized by the voice recognition unit 115. The recognition result is received by the copy range determination unit 114. As mentioned above, the copy range determination unit 114 determines the starting point or the endpoint according to the received string.

Still alternatively, the user may utter the word designated as the retry input in advance. The voice is recognized by the voice recognition unit 115, which outputs the recognition result to the controller 100. When judging that the recognition result indicates the word designated as the retry input in advance, the controller 100 performs the copy process again from the beginning.

The user can do the selection input, the string input, or the retry input by voice. This enables the user, who may have bad eyesight, to readily do the input.

4-3. A Plurality of Copy Ranges

The following will describe an example case in which a plurality of copy ranges are created from the text information. FIG. 18 is a timing chart illustrating an example of the copy process. In the illustration of FIG. 18, the start input and the end input are done in the middle of the speech output of the text information. In response to the end input, the controller 100 suspends the speech output of the text information and determines the copy range, as mentioned above. That is, the operation for determining the copy range based on the selection input or the string input is performed in the state in which the speech output of the text information is suspended. In the illustration of FIG. 18, the first selection input and the second selection input are done in the state in which the speech output is suspended. As mentioned above, the controller 100 determines the starting point of the copy range based on the first selection input and determines the endpoint based on the second selection input.

In response to the second selection input, the controller 100 resumes the speech output of the text information. When resuming the speech output of the text information, the controller 100 may pick up where the speech output has stopped or may return to the immediately preceding sentence. In response to the start input or the end input done by the user in the middle of the speech output, the controller 100 suspends the speech output of the text information again and then determines the copy range. From that time forward, the above-mentioned operation is repeated.

As mentioned above, the speech output of the text information is suspended when the copy range is determined. The speech output of the text information is resumed after the copy range is determined. Thus, the user can readily designate a plurality of copy ranges.

The above-mentioned method is merely an example, and any other method may be used. For example, the copy range determination unit 114 may accept the start inputs and the end inputs in pairs for designating a plurality of copy ranges during the speech output of the text information and then determine a plurality of copy range candidates. After the end of the speech output of the text information, the copy range determination unit 114 may determine the individual copy ranges for the individual copy range candidates based on the selection inputs or the string inputs.

4-4. Guidance on Electronic Apparatus

The electronic apparatus 1 may output, by voice, the guidance on the use of the electronic apparatus 1 for the above-mentioned copy operation. For example, the electronic apparatus 1 may output, by voice, a notification that (i) the text information will be output by voice, (ii) the user can designate the character or letter of his or her choice included in the text information as the copy starting point or the copy endpoint by doing an input at the timing of the speech output of the character or letter concerned, and (iii) the user can adjust the starting point or the endpoint by doing the selection input or the string input. The user can lean the copy operation accordingly.

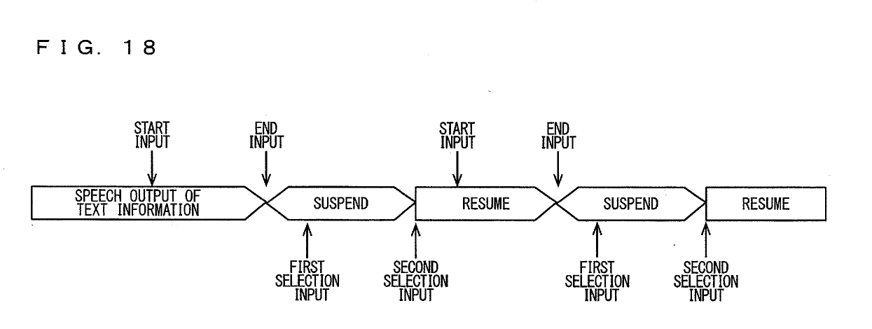

FIG. 19 illustrates a flowchart showing an example operation performed by the electronic apparatus 1. FIG. 19 illustrates a flowchart for providing guidance on the copy operation in the copy process shown in FIG. 9. In addition to the steps illustrated in FIG. 9, Step S0 is performed by the controller 100. Step S0 is performed prior to Step S1. In Step S0, the controller 100 causes, for example, the first sound output unit 170 to output a copy operation help message. For example, the help message may be determined in advance and prestored in a recording medium.

4-5. Speech Output Speed

The controller 100 may set a low speed as the speed of the speech output of the text information (a “speech output speed”, hereinafter). Specifically, the controller 100 may set the speed of the speech output of the text information to be lower in the copy process than in other processes.

For example, the text output unit 112 may output, together with the text information, speed information indicating the speech output speed, to the read aloud unit 113. The text output unit 112 can output, as the speed information, a value V1 in response to the input for starting the copy process. The text output unit 12 can output, as the speed information, a value V2 greater than the value V1 in response to the input for the speech output in a process other than the copy process. The read aloud unit 113 can generate a sound signal indicating the reading of the input text information based on the text information and the speed information. For example, the sound signal corresponding to a high speech-output speed can be generated from a sound signal corresponding to a low speech-output speed by shortening the time axis.

In a process other than the copy process, the text information is read aloud in, for example, the following case. When the first operation (e.g., a tap operation) is performed on the element displayed on the display screen 2a and functioning as the input button, the controller 100 may cause the first sound output unit 170 or the like to output the text information for describing the element. The user can learn about the function of the element accordingly.

In response to an input for selecting one mail from among the received mails in the inbox, the controller 100 may cause the first sound output unit 170 or the like to output the text information indicating the detailed contents of the received mail. The user can recognize the detailed contents of the received mail accordingly.

The low speech-output speed is not an absolute necessity for the above-mentioned speech output of the text information. In the copy process, meanwhile, the user needs to do the start input or the end input at the timing of the speech output of the character or letter of his or her choice in the text information. Thus, the controller 100 sets the low speech-output speed in the copy process. The text information is slowly read aloud in the copy process accordingly. The user can readily do the input at the timing of the speech output of the character or letter of his or her choice.

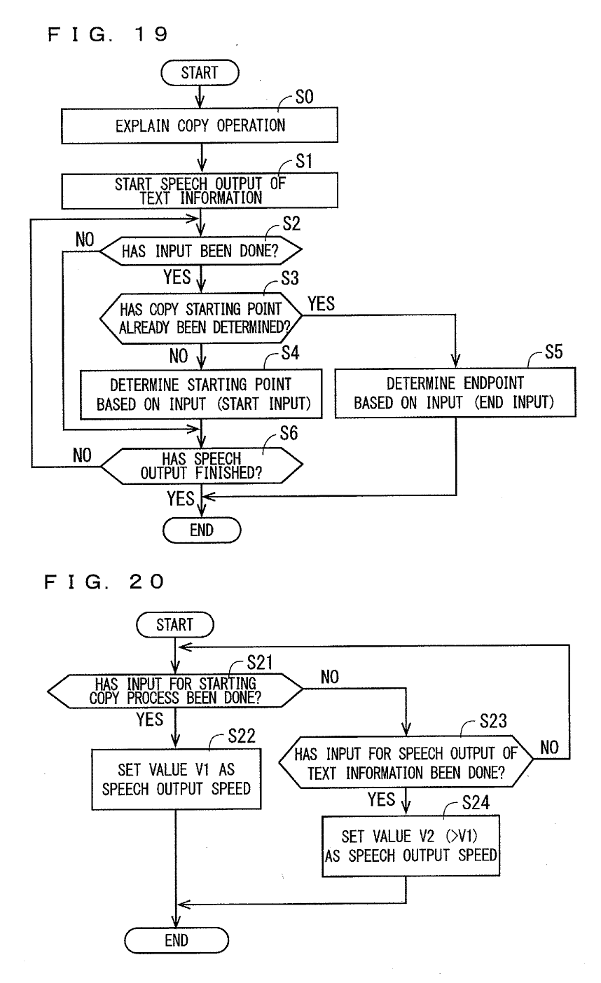

FIG. 20 illustrates a flowchart showing an example of the above-mentioned operation performed by the electronic apparatus 1. In Step S21, the controller 100 judges whether the input for starting the copy process has been done. The input may be an operation on the element E4 (see FIG. 7). When judging that the input has been performed, in Step S22, the controller 100 sets the value V1 as the speech output speed. For example, the text output unit 112 outputs, together with the text information displayed on the display screen 2a, the value V1 as the speed information to the read aloud unit 113.

When judging that the input for starting the copy process has not been done, the controller 100 judges in Step S23 whether the input for the speech output of the text information has been done. When judging that the input for the speech output of the text information has not been done, the controller 100 performs Step S21 again. When judging that the input for the speech output of the text information has been done, in Step S24, the controller 100 sets the value V2 as the speech output speed. The value V2 is greater than the value V1. For example, the text output unit 112 outputs, together with the text information corresponding to the input, the value V2 as the speed information to the read aloud unit 113.

4-6. Text Breakpoint

The controller 100 may cause the first sound output unit 170 to remain silent when encountering a sign indicative of the end of a sentence. The sign may be a punctuation mark such as a full stop (a period in English), an exclamation mark, or a question mark. The period over which no sound is output is also referred to as a “break period”. The speech output is suspended in between two sentences over the break period. The controller 100 may specify the duration of the break period. Specifically, the controller 100 may set the break period to be longer in the copy process than in other processes.

For example, the text output unit 112 may output, together with the text information, period information indicating the duration of the break period to the read aloud unit 113. The text output unit 112 can output, as the duration of the break period, a value T1 in response to the input for starting the copy process. The text output unit 112 can output, as the duration of the break period, a value T2 smaller than the value T1 in response to the input for the speech output of the text information in a process other than the copy process. The read aloud unit 113 can generate, based on the text information and the period information, a sound signal indicating the reading of the input text information.

The long break period allowed in the copy process helps the user in hearing the text information and doing the input at the timing of his or her choice. The user can readily do the input especially in the break period. In response to the user's end input in the break period, the copy range determination unit 114 may designate the relevant signal as the endpoint of the copy range.

No sound may be output when a text breakpoint signal (a punctuation mark such as a comma, a colon, or a semicolon) is encountered. In this case, the break period may be set as in the above description.

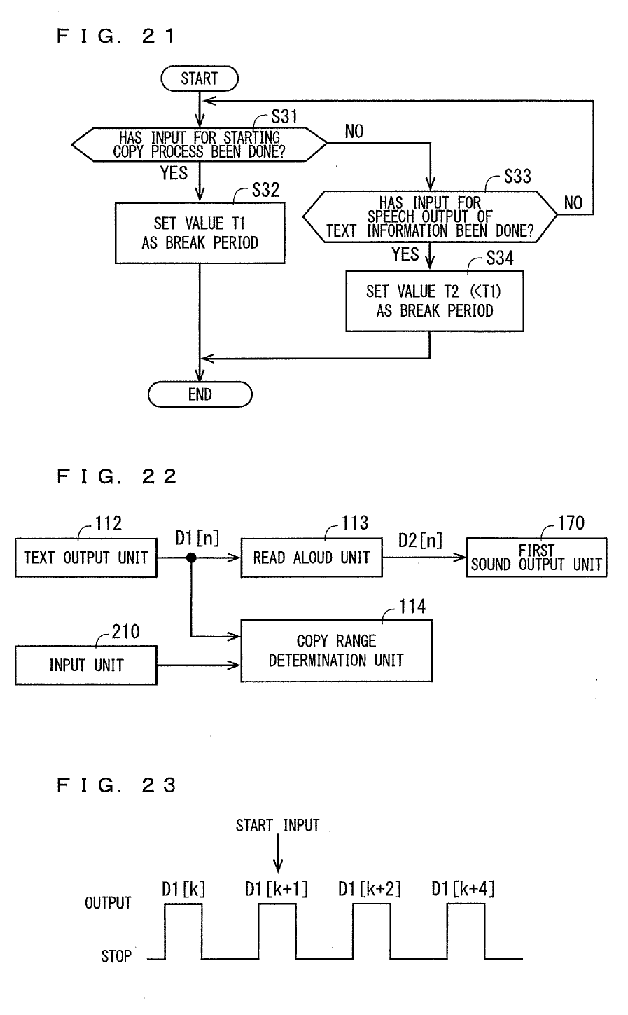

FIG. 21 illustrates a flowchart showing an example of the above-mentioned operation performed by the electronic apparatus 1. In Step S31, the controller 100 judges whether the input for starting the copy process has been done. When judging that the input has been done, in Step S32, the controller 100 sets the value T1 as the duration of the break period. For example, the text output unit 112 outputs, together with the text information displayed on the display screen 2a, the value T1 as the period information to the read aloud unit 113.

When judging that the input for starting the copy process has not been done, the controller 100 judges in step S33 whether the input for the speech output of the text information has been done. When judging that the input for the speech output of the text information has not been done, the controller 100 performs Step S31 again. When judging that the input for the speech output of the text information has been done, in Step S34, the controller 100 sets the value T2 as the duration of the break period. The value T2 is smaller than the value T1. For example, the text output unit 112 outputs, together with the text information corresponding to the input, the value T2 as the period information to the read aloud unit 113.

4-7. Copying File

A file may be attached to an email. Such a file is, for example, a text file or an image file and can be opened by using a predetermined application or the like. The functional unit 111 can associate a file to an email and store the file in the recording medium. In the case where such a file is attached to an email, the controller 100 may cause the first sound output unit 170 or the like to output file information by voice during the speech output of the email. The file information may include the presence or absence of the file and may also include a file name.

For example, the user may do an input while the first sound output unit 170 is reading the file information aloud. In this case, the copy range determination unit 114 may designate the file as the copy range. The controller 100 may copy the file. The user can copy not only a text but also a file accordingly.

For example, the text output unit 112 can create the text information indicating the detailed contents of the received mail with an attached file in the following manner. The text output unit 112 creates the text information by appropriately linking, in the stated order, the sender's information N1, the subject information SB1, the body information C1, and file name information included in the received mail. During the speech output of the text information, the sender's information N1, the subject information SB1, the body information C1, and the file information (e.g., a file name) are read aloud in the stated order.

In response to the start input done in the middle of the speech output of the body information C1, the copy range determination unit 114 designates the starting point of the copy range according to the start input, as mentioned above. In response to the end input done in the middle of the speech output of the file info nation, the copy range determination unit 114 may designate the end of the body information C1 as the endpoint. The copy range determination unit 114 may also designate, as an object to be copied, the file attached to the received mail.

In the above-mentioned example, the electronic apparatus 1 includes, the input unit 210, the sound output unit (the first sound output unit 170 or the second sound output unit 160), and the controller 100. It is not always required that the electronic apparatus 1 include all of them. For example, a system including the electronic apparatus 1 and an external device will be described below. In such a system, the external device can perform a wired communication or a wireless communication with the electronic apparatus 1. The external device includes the input unit 210 and/or the sound output unit. The external device is, for example, a wearable device (e.g., a headset). The headset is to be worn by the user on his or her head and includes both a sound input unit (e.g., a microphone), which is an example of the input unit 210, and a sound output unit (e.g., a speaker). The user can accordingly catch the text output by voice from the speaker of the headset and do an input to the microphone at the timing of his or her choice.

In effect, the input unit 210, the sound output unit, and the individual functional units of the controller 100 are included in the individual devices as appropriate. These devices may communicate with one another to perform the above-mentioned control. In this case, the system formed by these devices includes the input unit 210, the sound output unit, and the controller 100.

### Second Embodiment

In a second embodiment, the following will describe the technique for determining which part of the text information is read aloud at the timing of the user's input (the start input or the end input).

The text output unit 112 can divide the text information into sections and then output, to the read aloud unit 113, the text information per section. Each section may correspond to a character or a letter. Alternatively, each section may correspond to a word. Still alternatively, each section may correspond to a plurality of words.

FIG. 22 schematically illustrates part of the electrical configuration of the electronic apparatus 1. For example, the text output unit 112 can output a section D1[n] of the text information to the read aloud unit 113. The read aloud unit 113 can generate a sound signal D2[n] indicating the reading of the section D1[n] and then output the sound signal D2[n] to the first sound output unit 170 or the like. The first sound output unit 170 can convert the sound signal D2[n] into a sound and then output the sound.

FIG. 23 illustrates an example timing chart associated with the text output unit 112. For example, the text output unit 112 outputs a section D1[k]. After a lapse of a predetermined period of time, the text output unit 112 outputs a section D1[k+1] following the section D1[k]. This operation is repeated, so that the text output unit 112 can output the entire text information.

The expiration of the predetermined period of time is not an essential condition for the text output unit 112 to perform the above-mentioned operation. When the condition that a sound signal D2[k] is output by the read aloud unit 113 is satisfied, the text output unit 112 may output the section D1[k+1] following the section D1[k]. Upon completion of the output of the sound signal D2[k] corresponding to the section D1[k], the read aloud unit 113 reports the completion of output to the text output unit 112. In response to the report, the text output unit 112 outputs the section D1[k+1] following the section D1[k] to the read aloud unit 113. Similarly to the above, this operation is repeated, so that the text output unit 112 can output the entire text information.

In a case where the timing of the user's input is in between the timing of the output of the end of the section D1[k] by the text output unit 112 and the timing of the output of the beginning of the section D1[k+1] following the section D1[k] by the text output unit 112, it is judged that the section D1[k] is read aloud at the timing of the user's input. Conversely, it is judged that the user's input is done in the middle of the speech output of the section D1[k].

The copy range determination unit 114 receives, from the text output unit 112, information on the section that is currently read aloud. In the illustration of FIG. 22, the text output unit 112 outputs the section D1[n] in the text information to the copy range determination unit 114 as well as the read aloud unit 113. When receiving the input from the input unit 210, the copy range determination unit 114 determines the copy range based on the section D1[n] most recently received from the text output unit 112. When receiving the start input from the input unit 210, the copy range determination unit 114 may designate, as the starting point of the copy range, the beginning of the section D1[n], which is the most recently received section. In the illustration of FIG. 23, the start input has been done in the middle of the output of the section D1[k+1]. In this case, the copy range determination unit 114 designates, for example, the beginning of the section D1[k+1] as the copy starting point. Similarly, upon receipt of the end input, the copy range determination unit 114 may designate, for example, the end of the most recently received section as the endpoint of the copy range.

Thus, in the second embodiment, the electronic apparatus 1 can determine which part of the text information is read aloud at the timing of the user's input, based on the output from the text output unit 112.

In some embodiments, the text output unit 112 does not output the section D1[n] to the copy range determination unit 114. Instead, the read aloud unit 113 outputs the sound signal D2[n] to the copy range determination unit 114. Similarly to the above, the copy range determination unit 114 can judge that the sound signal D2[n], which is the most recently received sound signal, is read aloud at the timing of the start input or the end input.

The technique according to the second embodiment is, as a matter of course, applicable to the first embodiment and is also applicable to other embodiments.

While the electronic apparatus, the method for controlling an electronic apparatus, and the recording medium have been described above in detail, the foregoing description is in all aspects illustrative and not restrictive. The various modifications described above are applicable in combination as long as they are consistent with each other. It is understood that numerous modifications which have not been exemplified can be devised without departing from the scope of the present disclosure.

What is claimed is:

1. An electronic apparatus comprising:
an input unit;
a sound output unit; and
at least one processor configured to perform a copy process in which the at least one processor
causes the sound output unit to perform a speech output of first text information,
judges whether a first input to the input unit has been done by a user during the speech output, and
determines, when judging that the first input has been done, a copy range in the first text information based on a first timing of the first input.

2. The electronic apparatus according to claim 1,
wherein the at least one processor determines, based on a section of the first text information output by voice at the first timing, a demarcation point that is a starting point or an endpoint of the copy range.

3. The electronic apparatus according to claim 1,
wherein the at least one processor
determines a starting point of the copy range based on a section of the first text information output by voice at the first timing, and
designates the end of the first text information as an endpoint of the copy range when judging that the speech output of the first text information has finished with no input for determining the endpoint of the copy range being done after the first input.

4. The electronic apparatus according to claim 1,
wherein, in a first process, the at least one processor
determines a candidate for a demarcation point that is a starting point or an endpoint of the copy range based on the first timing,
offers a plurality of options based on the candidate for the demarcation point, and
determines, in response to a second input to the input unit for selecting one option from among the plurality of options, the demarcation point based on the one option.

5. The electronic apparatus according to claim 4,
wherein each of the plurality of options indicates a character or a letter preceding the candidate for the demarcation point in the first text information.

6. The electronic apparatus according to claim 1,
wherein, in a first process, the at least one processor
determines a candidate for a demarcation point that is a starting point or an endpoint of the copy range based on the first timing,
judges, in response to a second input to the input unit for inputting at least one string, whether the at least one string is included in the first text information, and
determines the demarcation point based on the at least one string in the first text information when judging that the at least one string is included in the first text information.

7. The electronic apparatus according to claim 6,
wherein in a case where the at least one string comprises a plurality of strings in the first text information, the at least one processor determines the demarcation point based one of the plurality of strings in the first text information that is closest to the candidate for the demarcation point.

8. The electronic apparatus according to claim 6,
wherein in a case where the at least one string comprises a plurality of strings in the first text information, the at least one processor determines the demarcation point based on one of the plurality of strings in the first text information that precedes the candidate for the demarcation point and is closest to the candidate for the demarcation point.

9. The electronic apparatus according to claim 4,
wherein the at least one processor
judges whether the first timing is a timing in the middle of a speech output of a reading of a word included in the first text information,
determines the demarcation point in the first process when making a positive judgment, and
designates, as the demarcation point, a section of the first text information output by voice at the first timing when making a negative judgment.

10. The electronic apparatus according to claim 4, wherein
the input unit includes a sound input unit; and
the second input comprises a voice input.

11. The electronic apparatus according to claim 1,
wherein the at least one processor performs the copy process again from the beginning in response to a third input to the input unit done by a user in the middle of the copy process.

12. The electronic apparatus according to claim 1,
wherein the at least one processor
causes the sound output unit to output second text information by voice in response to a fourth input to the input unit done by a user,
performs the copy process in response to a fifth input different from the fourth input to the input unit done by the user, and
causes the sound output unit to output the first text information in the copy process at a speed lower than a speed at which the second text information is read aloud.

13. The electronic apparatus according to claim 1,
wherein the at least one processor
causes the sound output unit to output second text information in response to a fourth input to the input unit done by a user,
performs the copy process in response to a fifth input different from the fourth input to the input unit done by the user, and
sets a break period over which no sound is output in between two sentences to be longer in the speech output of the first text information than in the speech output of the second text information and causes the sound output unit to output the first text information by voice in the copy process with the break period.

14. The electronic apparatus according to claim 1,
wherein the at least one processor causes the sound output unit to output, by voice, copy information included in the copy range in the first text information.

15. The electronic apparatus according to claim 1, wherein
the first text information comprises a plurality of sections, and
the at least one processor
outputs, to the sound output unit, the first text information per section, and
determines the copy range based on one of the plurality of sections output at the first timing.

16. A method for controlling an electronic apparatus, comprising:
causing a sound output unit to perform a speech output of first text information;
judging whether a first input to an input unit has been done by a user during the speech output; and
determining, when it is judged that the first input has been done, a copy range in the first text information based on a first timing of the first input.

17. A non-transitory computer readable recording medium that stores a control program for controlling an electronic apparatus, the control program causing the electronic apparatus to execute the steps of:
causing a sound output unit to perform a speech output of first text information;
judging whether a first input to an input unit has been done by a user during the speech output; and
determining, when it is judged that the first input has been done, a copy range in the text information based on a first timing of the first input.
